(19) United States
(12) Patent Application Publication
(10) Pub. No.: US 2013/0183521 A1
(43) Pub. Date: Jul. 18, 2013

(54) TRANSLUCENT LIGHT-SHIELDING TAPE

(71) Applicant: NITTO DENKO CORPORATION, Osaka (JP)

(72) Inventors: Noboru YOSHIDA, Osaka (JP); Takahisa MIZUTORI, Osaka (JP); Toshihide SUZUKI, Osaka (JP); Masaaki SATOU, Osaka (JP)

(73) Assignee: NITTO DENKO CORPORATION, Osaka (JP)

(21) Appl. No.: 13/743,870

(22) Filed: Jan. 17, 2013

(30) Foreign Application Priority Data
Jan. 18, 2012 (JP) 2012-008336

(51) Int. Cl. C09J 7/02; B32B 27/08

(52) U.S. Cl. CPC C09J 7/0296; B32B 27/08
USPC 428/354

(57) ABSTRACT

A translucent light-shielding tape has a base material layer, a light-shielding layer and an adhesive agent layer. The base material layer is formed with a plastic material such as polyethylene terephthalate and the like. The light-shielding layer is laminated on one of the main surfaces of the base material layer. The light-shielding layer is, for example, a black print layer formed with printing of black ink. The adhesive agent layer is laminated on the other of the main surfaces of the base material layer. As the adhesive agent layer, an acrylic-based polymer is suitably used. The translucent light-shielding tape has 0.010 to 10% of the permeability with regards to light of 550 nm.

### BACKGROUND OF THE INVENTION

1. Field of the Invention

The present invention relates to an adhesive tape having light-shielding property.

2. Description of the Related Art

An adhesive tape having light-shielding property (hereinafter, referred to as a light-shielding adhesive tape) is conventionally known. Examples of the use of the light-shielding adhesive tape include light-shielding as attached to electronic equipment such as an IC chip where malfunction from light leakage occurs, or properties thereof change.

### CITATION LIST

### Patent Literature

Patent Literature 1: JP 2011-214010 A

When an adhesive tape is attached to a light-shielding adherend, there may be a case where an adhesive tape having greater area than that of the light-shielding region of the adherend is be attached to the adherend, and then a process of excising an unnecessary portion is performed. Herein, in cutting the adhesive tape, the back face of the adherend, which is a side opposite to the face to which the adhesive tape is attached, is irradiated with backlight, and the shape of the adherend is grasped from the light that is permeated the adhesive tape, and a process of cutting the adhesive tape is performed in accordance with said shape.

However, when the above light-shielding adhesive tape is attached to the adherend, light is also blocked by the light-shielding adhesive tape at the time of irradiating the back face of the adherend with backlight, and thus it has been difficult to grasp the shape of the adherend through the adhesive tape. Therefore, there was a problem that it was not easy to cut the unnecessary portion of the light-shielding adhesive tape with irradiation of backlight.

### SUMMARY OF THE INVENTION

The present invention has been done in view of such problem, and an object of the present invention is to provide a translucent light-shielding tape having both of light-shielding property with regards to an adherend and translucency at the time of backlight irradiation.

An aspect of the present invention is a translucent light-shielding tape. Said translucent light-shielding tape is characterized by having a base material layer composed of a plastic material, a light-shielding layer laminated on one of the main surfaces of the base material layer, and an adhesive agent layer laminated on the other of the main surfaces of the base material layer, and having 0.010 to 10% of permeability with regards to light of 550 nm.

According to the translucent light-shielding tape of the above aspect, it is possible to render a translucent light-shielding tape to have both of light-shieldingproperty with regards to an adherend and translucency at the time of backlight irradiation.

In the translucent light-shielding tape of the above aspect, a thickness of the light-shielding layer may be 5 μm or less. The light-shielding layer maybe a black print layer. The plastic material may be polyethylene terephthalate. In addition, the adhesive agent layer may contain an acrylic-based polymer having (meth) acrylic acid alkyl ester as a main monomer ingredient.

Furthermore, a suitable combination of the respective elements described above is encompassed within the scope of the invention for which the protection is sought by the patent by the present patent application.

### BRIEF DESCRIPTION OF THE DRAWINGS

FIG. 1 is a schematic diagram that illustrates the layer constitution of the translucent light-shielding tape according to an embodiment;

FIG. 2 is a graph that illustrates dependence of the permeability on a wavelength in each adhesive tape of Examples 1 and 2, and Comparative Examples 1 to 4;

FIG. 3 is a graph that illustrates dependence of the permeability on a wavelength in each adhesive tape of Examples 1 and 2, and Comparative Examples 2 to 4; and

FIG. 4 illustrates photographs of the adhesive tapes of Examples 1 and 2 and Comparative Examples 1 to 4 when the adhesive tapes are irradiated with backlight.

### DETAILED DESCRIPTION OF THE INVENTION

The invention will now be described by reference to the preferred embodiments. This does not intend to limit the scope of the present invention, but to exemplify the invention.

Hereinafter, embodiments of the present invention will be described with reference to the figures.

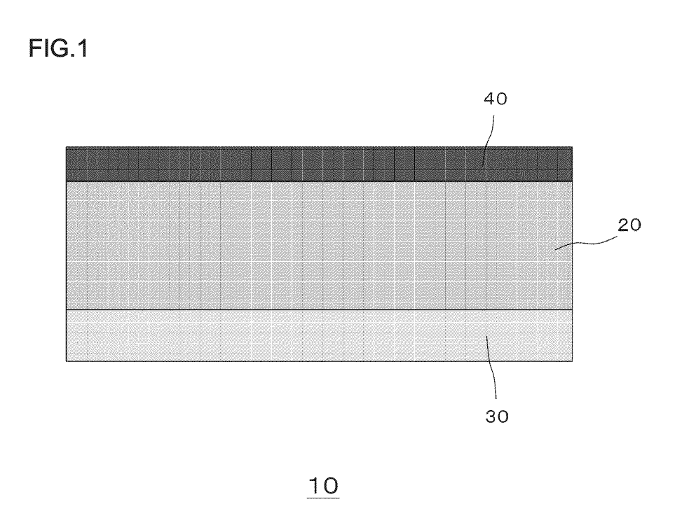

FIG. 1 is a schematic diagram that illustrates the layer constitution of a translucent light-shielding tape 10 according to an embodiment. The translucent light-shielding tape 10 includes a base material layer 20, a light-shielding layer 30 and an adhesive agent layer 40. The translucent light-shielding tape 10 according to the embodiment has 0.010 to 10% of the permeability (%) with regards to light of 550 nm.

Furthermore, the permeability (%) of the translucent light-shielding tape 10 is calculated by irradiating one surface of the translucent light-shielding tape 10 with light having a wavelength of 550 nm, and measuring the intensity of light that is permeated the other face using a spectrophotometer manufactured by Hitachi, Ltd (device name: “U4100 Type spectrophotometer”).

As the base material layer 20, a plastic material is used. The plastic material is not particularly limited, and examples of the plastic material include polyester such as polyethylene terephthalate and polybutylene terephthalate, polyolefin such as polyethylene and polypropylene, polyimide, polyamide, polycarbonate, and the like. The base material layer 20 is one obtained by molding the plastic material into a film shape or a sheet shape. To the base material layer 20, black pigments such as carbon black may be added within a range where the permeability described above is met. Specifically, those may be used, which is obtained by adding black pigments such as carbon black to the plastic material and molding the resultant into a film shape or a sheet shape. The thickness of the base material layer 20 is not particularly limited, but, for example, 5 to 500 rim, and preferably 10 to 100 μm.

The light-shielding layer 30 is laminated on one of the main surfaces of the base material layer 20. The light-shielding layer 30 in the present embodiment is, for example, a black print layer formed by printing on the base material layer 20 with a black ink. Furthermore, the light-shielding layer 30 may be formed with a method such as gravure printing and screen printing. The thickness of the light-shielding layer 30 is not particularly limited as long as the permeability described above is met, but for example, may be 5 μm or less, preferably 0.1 μm to 5 μm, more preferably 0.5 μm to 5 μm, further preferably 0.6 to 3 μm, and particularly preferably 0.8 to 2 μm.

The adhesive agent layer 40 is laminated on the other of the main surfaces of the base material layer 20. The adhesive agent layer 40 is not particularly limited, and various adhesive agents such as an acrylic-based adhesive agent, a rubber-based adhesive agent and a silicone-based adhesive agent may be used. Among them, the acrylic-based adhesive agent containing the acrylic-based polymer (A) as a main ingredient is suitably used. Said acrylic-based polymer (A) contains 50 mass % or more of a (meth) acrylic acid alkyl ester having a C1-20 straight or branched alkyl group as a monomer unit. The acrylic-based polymer (A) may use the (meth) acrylic acid alkyl ester having a C1-20 alkyl group alone or in combination of two or more kinds. The acrylic-based polymer (A) may be obtained by subjecting the (meth) acrylic acid alkyl ester to polymerization (for example, solution polymerization, emulsion polymerization, UV polymerization) together with a polymerization initiator.

The ratio of the (meth)acrylic acid alkyl ester having a C1-20 alkyl group is 50 mass % or more and 99.9 mass % or less, preferably 60 mass % or more and 95 mass % or less, and further preferably 70 mass % or more and 93 mass % or less with respect to the total amount of the monomer ingredients for preparing the acrylic-based polymer (A).

Examples of the (meth)acrylic acid alkyl ester having a C1-20 alkyl group include, for example, (meth)acrylic acid C1-20 alkyl esters such as methyl(meth)acrylate, ethyl(meth)acrylate, propyl(meth)acrylate, isopropyl(meth)acrylate, butyl(meth)acrylate, isobutyl(meth)acrylate, s-butyl(meth)acrylate, t-butyl(meth)acrylate, pentyl(meth)acrylate, isopentyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, heptadecyl(meth)acrylate, octadecyl(meth)acrylate, nonadecyl(meth)acrylate and eicosyl(meth)acrylate, preferably(meth)acrylic acid C2-14 alkyl esters, and further preferably (meth)acrylic acid C2-10 alkyl esters and the like. Furthermore, the (meth)acrylic acid alkyl ester refers to acrylic acid alkyl ester and/or methacrylic acid alkyl ester, and “(meth) . . . ” has similar meanings entirely.

Examples of the (meth)acrylic acid ester in addition to the (meth)acrylic acid alkyl ester include, for example, (meth)acrylic acid esters having an alicyclic hydrocarbon group such as cyclopentyl(meth)acrylate, cyclohexyl(meth)acrylate and isobornyl(meth)acrylate, (meth)acrylic acid esters having an aromatic hydrocarbon group such as phenyl(meth)acrylate, (meth)acrylic acid esters obtained from terpene compound-derived alcohols, and the like.

Furthermore, the acrylic-based polymer (A) may contain other monomer ingredients copolymerizable with the (meth)acrylic acid alkyl ester (copolymerizable monomer) as necessary for the purpose of improving cohesion, heat resistance, cross-linking, and the like. Accordingly, the acrylic-based polymer (A) may contain the copolymerizable monomer as a main ingredient together with the (meth)acrylic acid alkyl ester. As the copolymerizable monomer, a monomer having a polar group may be suitably used.

Specific examples of the copolymerizable monomer include carboxyl group-containing monomers such as acrylic acid, methacrylic acid, carboxyethylacrylate, carboxypentylacrylate, itaconic acid, maleic acid, fumaric acid, crotonic acid and isocrotonic acid; hydroxyl group-containing monomers such as hydroxyethyl(meth)acrylate, hydroxypropyl(meth)acrylate, hydroxybutyl(meth)acrylate, hydroxyhexyl(meth)acrylate, hydroxyoctyl(meth)acrylate, hydroxydecyl(meth)acrylate, hydroxylauryl(meth)acrylate and hydroxyalkyl(meth)acrylate such as (4-hydroxymethylcyclohexyl)methyl methacrylate; acid anhydride group-containing monomers such as anhydrous maleic acid and anhydrous itaconic acid; sulfonic acid group-containing monomers such as styrene sulfonic acid, allyl sulfonic acid, 2-(meth)acrylic amide-2-methylpropane sulfonic acid, (meth)acrylic amide propanesulfonic acid, sulfopropyl(meth)acrylate and (meth)acryloyloxy naphthalene sulfonic acid; phosphoric acid group-containing monomers such as 2-hydroxyethylacryloyl phosphate; (N-substituted)amide-based monomers such as (meth)acrylic amide, N,N-dimethyl(meth)acrylic amide, N,N-diethyl(meth)acrylic amide, N-isopropyl(meth)acrylic amide, N-butyl(meth)acrylic amide, N-methylol(meth)acrylic amide, N-methylol propane(meth)acrylic amide,

N-methoxymethyl(meth)acrylic amide and N-butoxymethyl(meth)acrylic amide; succinimide-based monomers such as N-(meth)acryloyloxymethylene succinimide, N-(meth)acryloyl-6-oxyhexamethylene succinimide and N-(meth)acryloyl-8-oxyhexamethylene succinimide; maleimide-based monomers such as N-cyclohexyl maleimide, N-isopropylmaleimide, N-laurylmaleimide and N-phenylmaleimide; itaconicimide-based monomers such as N-methylitaconicimide, N-ethylitaconicimide, N-butylitaconicimide, N-octylitaconicimide, N-2-ethylhexylitaconic imide, N-cyclohexylitaconicimide and N-laurylitaconicimide; vinyl esters such as vinyl acetate and vinyl propionate; nitrogen-containing heterocyclic ring-based monomers such as N-vinyl-2-pyrrolidone, N-methylvinyl pyrrolidone, N-vinyl pyridine, N-vinyl piperidone, N-vinyl pyrimidine, N-vinylpiperazine, N-vinylpyrazine, N-vinylpyrrole, N-vinyl imidazole, N-vinyl oxazole, N-(meth)acryloyl-2-pyrrolidone, N-(meth)acryloyl piperidine, N-(meth)acryloyl pyrrolidine and N-vinyl morpholine; N-vinyl carbonic acid amides; lactam-based monomers such as N-vinyl caprolactam; cyano-containing monomers such as acrylonitrile and methacrylonitrile;aminoalkyl(meth)acrylate-based monomers such as aminoethyl(meth)acrylate, N,N-dimethylaminoethyl(meth)acrylate, N,N-dimethylaminoethyl(meth)acrylate and t-butylaminoethyl(meth)acrylate; alkoxyalkyl(meth)acrylate-based monomers such as methoxyethyl(meth)acrylate and ethoxyethyl(meth)acrylate; styrene-based monomers such as styrene and α-methyl styrene; epoxy group-containing acrylic-based monomers such as glycidyl(meth)acrylate ; glycol-based acrylic ester monomers such as polyethylene glycol(meth)acrylate, polypropylene glycol(meth)acrylate, methoxyethylene glycol(meth)acrylate and methoxypolypropylene glycol(meth)acrylate; acrylic acid ester-based monomers having a heterocyclic ring, a halogen atom, a silicon atom and the like such as tetrahydrofurfuryl(meth)acrylate, fluorine(meth)acrylate and silicone(meth)acrylate; olefin-based monomers such as isoprene, butadiene and isobutylene; vinyl ether-based monomers such as methylvinyl ether and ethylvinyl ether; vinyl esters such as vinyl acetate and vinyl propionate; aromatic vinyl compounds such as styrene and vinyl toluene; olefins or dienes such as ethylene, butadiene, isoprene and isobutylene; vinyl ethers such as vinylalkyl ether; vinyl chloride; alkoxyalkyl(meth)acrylate-based monomers such as methoxyethyl(meth)acrylate and ethoxyethyl(meth)acrylate; sulfonic acid group-containing monomers such as sodium vinyl sulfonate; imide group-containing monomers such as cyclohexyl maleimide and isopropyl maleimide; isocyanate group-containing monomers such as 2-isocyanate ethyl(meth)acrylate; fluorine atom-containing (meth)acrylates; silicon atom-containing (meth)acrylates and the like. Furthermore, these copolymerizable monomers may be used in one kind or two or more kinds.

When the acrylic-based polymer (A) contains copolymerizable monomers together with (meth)acrylic acid alkyl ester as a main ingredient, carboxyl group-containing monomers may be suitably used. Among them, acrylic acids may be suitably used. The use amount of the copolymerizable monomer is not particularly limited, but may contain the copolymerizable monomer usually in 0.1 to 30 mass %, preferably 0.5 to 20 mass % and further preferably 1 to 15 mass % with respect to the total amount of the monomer ingredients for preparing the acrylic-based polymer (A).

By the copolymerizable monomer being contained in 0.1 mass % or more, it is possible to prevent decline of cohesion of the adhesive tape, and obtain high shearing force. In addition, by the copolymerizable monomer being contained in 30 mass % or less, it is possible to prevent too high cohesion, and improve sticky feeling at normal temperature (25° C.)

In addition, the acrylic-based polymer (A) may contain a multi-functional monomer as necessary in order to adjust cohesion of the adhesive agent layer 40 to be formed.

Examples of the multi-functional monomer include, for example, (poly)ethyleneglycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, 1,2-ethylene glycol di(meth)acrylate, 1,6-hexanediol di(meth)acrylate, 1,12-dodecandiol di(meth)acrylate, trimethylol propane tri(meth)acrylate, tetramethylol methane tri(meth)acrylate, allyl(meth)acrylate, vinyl(meth)acrylate, divinyl benzene, epoxy acrylate, poly ester acrylate, urethane acrylate, butyldiol(meth)acrylate, hexyldiol(meth)acrylate and the like. Among them, trimethylol propane tri(meth)acrylate, hexanediol di(meth)acrylate or dipentaerythritol hexa(meth)acrylate may be suitably used. The multi-functional (meth)acrylate may be used alone or in combination of two or more kinds.

The use amount of the multi-functional monomer varies depending on the molecular weight, the number of functional groups and the like, but the multi-functional monomer is added to be 0.01 to 3.0 mass %, preferably 0.02 to 2.0 mass %, and further preferably 0.03 to 1.0 mass % with respect to the total amount of the monomer ingredients for preparing the acrylic-based polymer (A).

If the use amount of the multi-functional monomer is more than 3.0 mass % with respect to the total amount of the monomer ingredients for preparing the acrylic polymer (A), there are, for example, too much cohesion of the adhesive agent layer 40, and decline of adhesion, and the like. On the other hand, if the use amount of the multi-functional monomer is less than 0.01 mass %, there are, for example, decline of cohesion of the adhesive agent layer 40, and the like.

<Polymerization Initiator>

In preparation of the acrylic-based polymer (A), a polymerization initiator such as a heat polymerization initiator or a light polymerization initiator (light initiator) may be used to utilize curing reaction by heat or ultraviolet ray, whereby to easily form the acrylic-based polymer (A). Particularly, the light polymerization initiator may be suitably used from an advantage of shortening the polymerization time, and the like. The polymerization initiator may be used alone or in combination of two or more kinds.

Examples of the heat polymerization initiator include, for example, azo-based polymerization initiators [for example, 2,2′-azobisisobutyronitrile, 2,2′-azobis-2-methylbutyronitrile, 2,2′-azobis(2-methylpropionic acid)dimethyl, 4,4′-azobis-4-cyanovaleric acid, azobisisovalero nitrile, 2,2′-azobis(2-amidinopropane)dihydrochloride, 2,2′-azobis[2-(5-methyl-2-imidazoline-2-yl)propane]dihydrochloride, 2,2′-azobis(2-methylpropionic amidine)disulfate, 2,2′-azobis(N,N′-dimethylene isobutyl amidine)dihydrochloride and the like], peroxide-based polymerization initiators (for example, dibenzoyl peroxide, t-butylpermaleate, lauroyl peroxide and the like), redox-based polymerization initiators, and the like.

The use amount of heat polymerization initiator is not particularly limited, and may be within a range where conventional heat polymerization initiators are used.

The light polymerization initiator is not particularly limited, and examples of the light polymerization initiator to be used include, for example, a benzoin ether-based light polymerization initiator, an acetophenone-based light polymerization initiator, an α-ketol-based light polymerization initiator, an aromatic sulfonyl chloride-based light polymerization initiator, a photoactive oxime-based light polymerization initiator, a benzoin-based light polymerization initiator, a benzyl-based light polymerization initiator, a benzophenone-based light polymerization initiator, a ketal-based light polymerization initiator, a thioxanthone-based light polymerization initiator, an acyl phosphine oxide-based light polymerization initiator, and the like.

Specifically, examples of the benzoin ether-based light polymerization initiator include, for example, benzoin methyl ether, benzoin ethyl ether, benzoin propyl ether, benzoin isopropyl ether, benzoin isobutyl ether, 2,2-dimethoxy-1,2-diphenylethane-1-one [manufactured by BASF Corporation, trade name: IRGACURE 651], anisoin, and the like; examples of the acetophenone-based light polymerization initiator include, for example, 1-hydroxycyclohexylphenyl ketone [manufactured by BASF Corporation, trade name: IRGACURE 184], 4-phenoxydichloroacetophenone, 4-t-butyl-dichloroacetophenone, 1-[4-(2-hydroxyethoxy)-phenyl]-2-hydroxy-2-methyl-1-propane-1-one [manufactured by BASF Corporation, trade name: IRGACURE 2959], 2-hydroxy-2-methyl-1-phenyl-propane-1-one [manufactured by BASF Corporation, trade name: DAROCUR 1173], methoxyacetophenone, and the like; examples of the α-ketol-based light polymerization initiator include, for example, 2-methyl-2-hydroxypropiophenone, 1-[4-(2-hydroxyethyl)-phenyl]-2-hydroxy-2-methylpropane-1-one, and the like; examples of the aromatic sulfonyl chloride-based light polymerization initiator include, for example, 2-naphthalenesulfonyl chloride, and the like; and examples of the photoactive oxime-based light polymerization initiator include, for example, 1-phenyl-1,1-propanedione-2-(O-ethoxycarbonyl)-oxime, and the like.

In addition, examples of the benzoin-based light polymerization initiator include, for example, benzoin and the like. Examples of the benzyl-based light polymerization initiator include, for example, benzyl and the like; examples of the benzophenone-based light polymerization initiator include, for example, benzophenone, benzoyl benzoic acid, 3,3′-dimethyl-4-methoxybenzophenone, polyvinyl benzophenone, α-hydroxycyclohexylphenyl ketone, and the like; examples of the ketal-based light polymerization initiator include, for example, benzyldimethyl ketal, and the like; examples of the thioxanthone-based light polymerization initiator include, for example, thioxanthone, 2-chlorothioxanthone, 2-methyl thioxanthone, 2,4-dimethylthioxanthone,isopropylthioxanthone, 2,4-dichlorothioxanthone, 2,4-diethyl thioxanthone, isopropyl thioxanthone, 2,4-diisopropylthioxanthone, dodecylthioxanthone, and the like.

Examples of the acyl phosphine-based light polymerization initiator include, for example, bis(2,6-dimethoxybenzoyl)phenyl phosphine oxide, bis(2,6-dimethoxybenzoyl)(2,4,4-trimethylpentyl) phosphine oxide, bis(2,6-dimethoxybenzoyl)-n-butyl phosphine oxide, bis(2,6-dimethoxybenzoyl)-(2-methylpropane-1-yl) phosphine oxide, bis(2,6-dimethoxybenzoyl)-(1-methylpropane-1-yl)phosphine oxide, bis(2,6-dimethoxybenzoyl)-t-butyl phosphine oxide, bis(2,6-dimethoxybenzoyl)cyclohexyl phosphine oxide, bis(2,6-dimethoxybenzoyl)octyl phosphine oxide, bis(2-methoxybenzoyl)(2-methylpropane-1-yl)phosphine oxide, bis(2-methoxybenzoyl)(1-methylpropane-1-yl)phosphine oxide, bis(2,6-diethoxybenzoyl)(2-methylpropane-1-yl)phosphine oxide, bis(2,6-diethoxybenzoyl)(1-methylpropane-1-yl)phosphine oxide, bis(2,6-dibutoxybenzoyl)(2-methylpropane-1-yl)phosphine oxide, bis(2,4-dimethoxybenzoyl)(2-methylpropane-1-yl)phosphine oxide, bis(2,4,6-trimethylbenzoyl)(2,4-dipentoxyphenyl)phosphine oxide, bis(2,6-dimethoxybenzoyl)benzyl phosphine oxide, bis(2,6-dimethoxybenzoyl)-2-phenylpropyl phosphine oxide, bis(2,6-dimethoxybenzoyl)-2-phenylethyl phosphine oxide, bis(2,6-dimethoxybenzoyl)benzyl phosphine oxide, bis(2,6-dimethoxybenzoyl)-2-phenylpropyl phosphine oxide, bis(2,6-dimethoxybenzoyl)-2-phenylethyl phosphine oxide, 2,6-dimethoxybenzoylbenzylbutyl phosphine oxide, 2,6-dimethoxybenzoylbenzyloctyl phosphine oxide, bis(2,4,6-trimethylbenzoyl)-2,5-diisopropylphenyl phosphine oxide, bis(2,4,6-trimethylbenzoyl)-2-methylphenyl phosphine oxide, bis(2,4,6-trimethylbenzoyl)-4-methylphenyl phosphine oxide, bis(2,4,6-trimethylbenzoyl)-2,5-diethylphenylphosphine oxide, bis(2,4,6-trimethylbenzoyl)-2,3,5,6-tetramethylphenyl phosphine oxide, bis(2,4,6-trimethylbenzoyl)-2,4-di-n-butoxyphenyl phosphine oxide, 2,4,6-trimethylbenzoyldiphenyl phosphine oxide, bis(2,6-dimethoxybenzoyl)-2,4,4-trimethylpentyl phosphine oxide, bis(2,4,6-trimethylbenzoyl)isobutyl phosphine oxide, 2,6-dimethoxybenzoyl-2,4,6-trimethylbenzoyl-n-butyl phosphine oxide, bis(2,4,6-trimethylbenzoyl)phenyl phosphine oxide, bis (2,4,6-trimethylbenzoyl)-2,4-dibutoxyphenyl phosphine oxide, 1,10-bis[bis(2,4,6-trimethylbenzoyl)phosphine oxide]decane, tri(2-methylbenzoyl)phosphine oxide, and the like.

Particularly among them, the acyl phosphine-based light polymerization initiator is preferably bis(2,4,6-trimethylbenzoyl)phenyl phosphine oxide [manufactured by BASF Corporation, trade name: IRGACURE 819], bis(2,4,6-trimethylbenzoyl)-2,4-di-n-butoxyphenyl phosphine oxide, 2,4,6-trimethylbenzoyldiphenyl phosphine oxide [manufactured by BASF Corporation, trade name: Lucirin TPO], or bis(2,6-dimethoxybenzoyl)-2,4,4-trimethylpentyl phosphine oxide.

The use amount of the light polymerization initiator is notparticularly limited, but the light polymerization initiator is blended in an amount within a range of, for example, 0.01 to 5 parts by mass, preferably 0.05 to 3 parts by mass, and further preferably 0.08 to 2 parts by mass with respect to 100 parts by mass of the monomer ingredient for preparing the acrylic-based polymer (A).

Herein, if the use amount of the light polymerization initiator is less than 0.01 parts by mass, the polymerization reaction may be insufficient. If the use amount of the light polymerization initiator is more than 5 parts by mass, the light polymerization initiator absorbs ultraviolet rays, which may result that the ultraviolet rays do not reach the inside of the adhesive agent layer 40, and decline of the polymerization rate is led. The molecular weight of the produced polymer becomes small, leading to decrease of cohesion of the adhesive agent layer 40 formed, and a portion of the adhesive agent layer 40 may remain on the film when the adhesive agent layer 40 is released from the film, and the film may not be reutilized. Furthermore, the light polymerizable initiator may be used alone or in combination of two or more kinds.

In adjustment of the cohesion, a crosslinking agent may be also used in addition to the multi-functional monomer described above. As the crosslinking agent, conventionally used crosslinking agent may be used, and examples of the crosslinking agent include, for example, an epoxy-based crosslinking agent, an isocyanate-based crosslinking agent, a silicone-based crosslinking agent, an oxazoline-based crosslinking agent, an aziridine-based crosslinking agent, a silane-based crosslinking agent, an alkyl etherified melamine-based crosslinking agent, a metal chelate-based crosslinking agent, and the like. Particularly, the isocyanate-based crosslinking agent or epoxy-based crosslinking agent may be suitably used.

Specifically, examples of the isocyanate-based crosslinking agent include tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, tetramethyl xylylene diisocyanate, naphthalene diisocyanate, triphenyl methane triisocyanate, polymethylene polyphenyl isocyanate, and an adduct thereof with polyols such as trimethylol propane.

Examples of the epoxy-based crosslinking agent include bisphenol A, the epichlorohydrin type of an epoxy-based resin, ethylene glycidyl ether, polyethylene glycol diglycidyl ether, glycerin diglycidyl ether, glycerin triglycidyl ether, 1,6-hexanediol glycidyl ether, trimethylol propane triglycidyl ether, diglycidyl aniline, diamine glycidyl amine, N,N,N′,N′-tetraglycidyl-m-xylylene diamine and 1,3-bis(N,N-diglycidyl aminomethyl)cyclohexane and the like.

Various additives may be blended with the adhesive agent. Examples of such additives include, for example, a crosslinking agent such as an isocyanate-based crosslinking agent and an epoxy-based crosslinking agent; a tackifier such as a rosin derivative resin, a polyterpene resin, a petroleum resin and an oil-soluble phenol resin; a plasticizer; a filler; an antioxidant; a surfactant; a pigment (colorant), and the like.

A method of forming the adhesive agent layer 40 is not particularly limited, but for example, the adhesive agent layer 40 is formed by applying an adhesive agent onto a suitable support such as a separator and a base material to form the adhesive agent layer 40, and then subjecting the adhesive agent layer 40 to drying or curing (curing by heat or active energy line) as necessary. In addition, in performing the curing by active energy ray (light curing), oxygen is preferably blocked by attaching a suitable support such as a separator and a base material together onto the adhesive agent layer 40, or performing the light curing under nitrogen atmosphere, and the like, since the light polymerization reaction is inhibited with oxygen in the air. The suitable support used in formation of the adhesive agent layer 40 may be released at a suitable time when manufacturing the adhesive tape, or may be released when utilizing the adhesive tape after the manufacture.

The thickness of the adhesive agent layer 40 is suitably selected depending on the intended purpose of the adhesive tape, and is, for example, 1 to 300 μm, preferably 10 to 250 μm, and further preferably 30 to 200 μm or so. If the thickness of the adhesive agent layer 40 is too thin, sufficient adhesion may not be obtained in order to hold an adherend.

According to the translucent light-shielding tape 10 as described above, it is possible to obtain translucency at the time of backlight irradiation while ensuring sufficient light-shielding property with regards to an adherend that adheres to said tape. Therefore, by attaching a translucent light-shielding tape having greater size than that of an adherend, to the adherend, and then irradiating the side of the adhesive agent layer 40 with backlight, it is possible to grasp the shape of the adherend through the translucent light-shielding tape. Furthermore, based on the shape grasped, it is possible to cut the extraportion of the translucent light-shielding tape certainly and easily.

### EXAMPLES

Hereinafter, the present invention will be described based on Examples in detail, but the present invention is not limited to these Examples. Furthermore, “parts” in Examples means “parts by mass” unless otherwise stated.

(Manufacture of Adhesive Agent Composition)

70 Parts of butyl acrylate, 30 parts of 2 ethylhexyl acrylate, 3 parts of acrylic acid and 0.05 parts of 4-hydroxybutyl acrylate were subjected to solution polymerization for 6 hours using 0.08 parts of 2,2-azobisisobutyronitrile as a polymerization initiator in a mixed solution of toluene and ethyl acetate [toluene/ethyl acetate (mass ratio)=1/1], whereby to obtain an acrylic-based polymer having a weight average molecular weight of 500,000. To 100 parts of the acrylic-based polymer, 30 parts of a polymerization rosin pentaerythritol ester resin (trade name “Penser D125”, manufactured by Arakawa Chemical Industries, Ltd; softening point: 125° C.) and 3 parts of an isocyanate-based crosslinking agent (trade name “CORONATE L”, manufactured by NIPPON POLYURETHANE INDUSTRY CO., LTD.) were added, and the mixture was stirred and mixed to be uniform, where to prepare an adhesive agent (pressure-sensitive adhesive composition).

### Example 1

Ink printing was performed using black ink (print number of times: once) on one surface of a PET film (transparent) having 12 μm thickness entirely, and a light-shielding layer having 1 μm thickness was formed. An acrylic-based adhesive agent layer (thickness: 17 μm) was formed on the other surface of the PET film using the adhesive agent described above whereby to manufacture an adhesive tape (translucent light-shielding tape).

### Example 2

The adhesive tape of Example 2 was manufactured similarly to the adhesive tape of Example 1 except that the print number of times of black ink was twice, and the thickness of the light-shielding layer was 2 μm.

### Comparative Example 1

An acrylic-based adhesive agent layer (thickness: 18 μm) was formed using the adhesive agent described above having 12 μm thickness on one surface of a PET film (transparent) entirely whereby to manufacture an adhesive tape.

### Comparative Example 2

Ink printing was performed using black ink (print number of times: three times) on one surface of a PET film (transparent) having 12 μm thickness entirely, and a light-shielding layer having 3 μm thickness was formed. An acrylic-based adhesive agent layer (thickness: 13 μm) was formed using the adhesive agent described above on the other surface of the PET film whereby to manufacture an adhesive tape (light-shielding tape).

### Comparative Example 3

The adhesive tape of Comparative Example 3 was manufactured similarly to the adhesive tape of Comparative Example 2 except that the print number of times of black ink was four times, and the thickness of the light-shielding layer was 4 μm.

### Comparative Example 4

The adhesive tape of Comparative Example 4 was manufactured similarly to the adhesive tape of Comparative Example 2 except that the print number of times of black ink was five times, and the thickness of the light-shielding layer was 6 μm.

(Evaluation of Light-Shielding Property)

With respect to each adhesive tape of Examples 1 and 2 and Comparative Examples 1 to 4, one surface of the adhesive tape was irradiated with light of the wavelength region to be described below, and the intensity of light that is permeated the other surface was measured whereby to evaluate dependence of the permeability on the wavelength. The evaluation of the permeability was performed under the following conditions.

Equipment: U-4100 Spectrophotometer (manufactured by Hitachi, Ltd.)

Wavelength region: 380 nm to 780 nm

Light incidence angle: 0°

Wavelength scan speed: 300 nm/minute

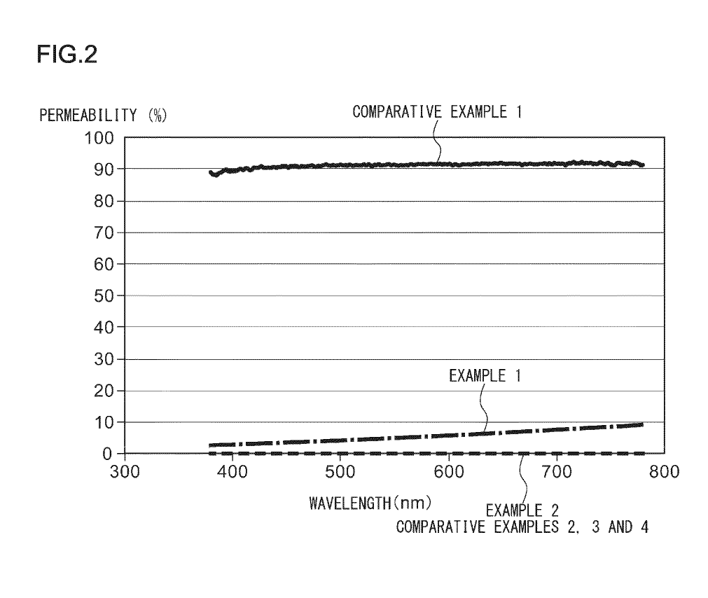

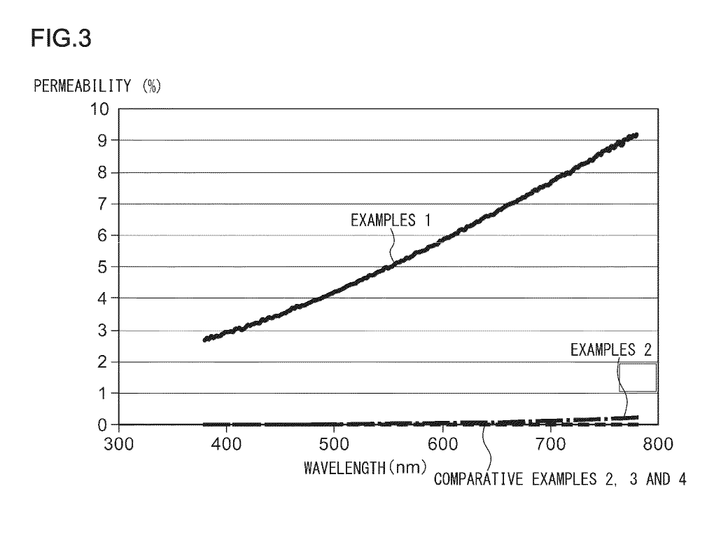

FIG. 2 is a graph that illustrates dependence of the permeability on the wavelength in each adhesive tape of Examples 1 and 2 and Comparative Examples 1 to 4. In addition, FIG. 3 is a graph that illustrates dependence of the permeability on the wavelength in each adhesive tape of Examples 1 and 2 and Comparative Example 2 to 4. As illustrated in FIG. 2 and FIG. 3, it was confirmed that the adhesive tapes of Examples 1 and 2 had sufficient light-shielding property in the visible light region.

Furthermore, the permeability (%) at light having a wavelength of 550 nm was calculated with respect to each adhesive tape of Examples 1 and 2 and Comparative Examples 1 to 4. The results obtained with respect to the permeability are listed in Table 1.

TABLE 1

| | Permeability (%) at 550 nm |
|---|---|
| Example 1 | 4.960 |
| Example 2 | 0.027 |
| Comparative Example 1 | 91.540 |
| Comparative Example 2 | 0.007 |
| Comparative Example 3 | 0.007 |
| Comparative Example 4 | 0.002 |

(Evaluation of Backlight Translucency)

The backlight translucency of each adhesive tape of Examples 1 and 2 and Comparative Examples 1 to 4 was evaluated with the method to be described below. The adhesive agent layer was attached to an adherend, and a columnar cylinder (diameter of circle: 80 mm, hight: 200 mm) was installed on the surface of the adhesive tape of the opposite side to the adhesive agent layer, and the side of the adhesive agent layer was irradiated with backlight (visible light). At this time, the location of the cylinder was regulated such that the end of the adherend was located in the cylinder.

The translucency was confirmed from the viewpoint whether the edge of the adherend could be found or not when the adhesive tape was visually observed through the columnar cylinder.

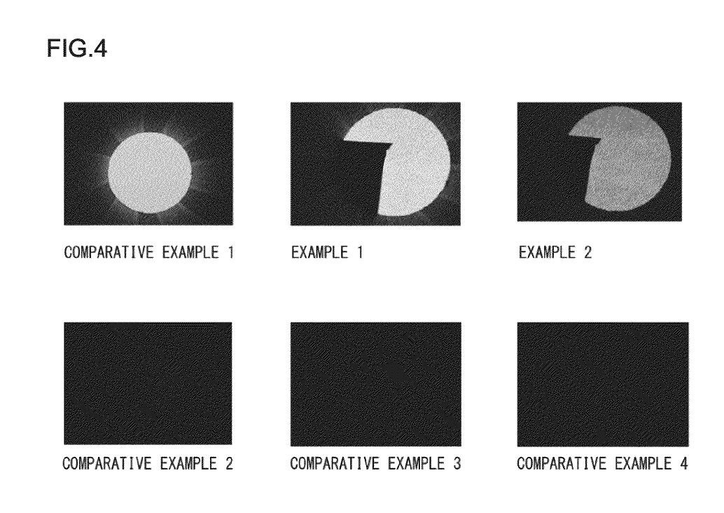

FIG. 4 illustrates the photographs at the time the adhesive tapes of Examples 1 and 2 and Comparative Examples 1 to 4 are irradiated with backlight. It was confirmed that Example 1 and Example 2 had sufficient translucency to allow confirmation of the edge shape of the adherend, although they had the backlight slightly light-shielded. It was confirmed that Comparative Example 1 had the backlight totally light-unshielded. It was confirmed that Comparative Example 2 had the backlight nearly light-shielded, and Comparative Examples 3 and 4 had the backlight completely light-shielded, any of which did not allow confirmation of the shape of the adherend.

1. A translucent light-shielding tape, comprising:
a base material layer composed of a plastic material,
a light-shielding layer laminated on one of the main surfaces of the base material layer, and
an adhesive agent layer laminated on the other of the main surfaces of the base material layer, wherein
the translucent light-shielding tape has 0.010 to 10% of the permeability with regards to light of 550 nm.

2. The translucent light-shielding tape according to claim 1, wherein the thickness of the light-shielding layer is 5 μm or less.

3. The translucent light-shielding tape according to claim 1, wherein the light-shielding layer is a black print layer.

4. The translucent light-shielding tape according to claim 1, wherein the plastic material is polyethylene terephthalate.

5. The translucent light-shielding tape according to claim 1, wherein
the adhesive agent layer includes an acrylic-based polymer having (meth)acrylic acid alkyl ester as a main monomer ingredient.

6. The translucent light-shielding tape according to claim 2, wherein the light-shielding layer is a black print layer.

7. The translucent light-shielding tape according to claim 2, wherein the plastic material is polyethylene terephthalate.

8. The translucent light-shielding tape according to claim 2, wherein the adhesive agent layer includes an acrylic-based polymer having (meth)acrylic acid alkyl ester as a main monomer ingredient.

9. The translucent light-shielding tape according to claim 3, wherein the adhesive agent layer includes an acrylic-based polymer having (meth)acrylic acid alkyl ester as a main monomer ingredient.

10. The translucent light-shielding tape according to claim 4, wherein the adhesive agent layer includes an acrylic-based polymer having (meth)acrylic acid alkyl ester as a main monomer ingredient.

11. The translucent light-shielding tape according to claim 6, wherein the adhesive agent layer includes an acrylic-based polymer having (meth)acrylic acid alkyl ester as a main monomer ingredient.

12. The translucent light-shielding tape according to claim 7, wherein the adhesive agent layer includes an acrylic-based polymer having (meth)acrylic acid alkyl ester as a main monomer ingredient.
